(19) United States
(12) Patent Application Publication
(10) Pub. No.: US 2025/0391842 A1
(43) Pub. Date: Dec. 25, 2025

(54) ANODE MIXTURE AND SOLID STATE BATTERY

(71) Applicant: TOYOTA JIDOSHA KABUSHIKI KAISHA, Toyota-shi (JP)

(72) Inventors: Ryosuke FURUYA, Gotemba-shi (JP); Jun YOSHIDA, Mishima-shi (JP); Hirofumi NAKAMOTO, Shizuoka-ken (JP); Chi Kuen WONG, Mishima-shi (JP); Shohei KAWASHIMA, Susono-shi (JP); Kazushige NOMOTO, Shizuoka-ken (JP)

(73) Assignee: TOYOTA JIDOSHA KABUSHIKI KAISHA, Toyota-shi (JP)

(21) Appl. No.: 19/236,173

(22) Filed: Jun. 12, 2025

(30) Foreign Application Priority Data
Jun. 25, 2024 (JP) 2024-101800

(51) Int. Cl. H01M 4/36; H01M 4/02; H01M 4/38; H01M 10/0562

(52) U.S. Cl. CPC H01M 4/364; H01M 4/386; H01M 10/0562; H01M 2004/021

(57) ABSTRACT

A main object of the present disclosure is to provide an anode mixture capable of obtaining an anode layer of which volume change due to charge and discharge is suppressed. The present disclosure achieves the object by providing an anode mixture including an anode active material and a solid electrolyte, wherein the anode mixture includes, as the anode active material, a secondary particle that is an aggregation of a plurality of primary particle; the primary particle is a Si-based active material containing a Si element; a particle size D₅₀ of the secondary particle is 2.5 μm or more and less than 20 μm; and a particle size D₅₀ of the solid electrolyte is 0.05 μm or more and less than 2.0 μm.

### TECHNICAL FIELD

The present disclosure relates to an anode mixture and a solid state battery.

### BACKGROUND ART

In recent years, the development of a battery has been actively carried out. For example, the development of a battery used for battery electric vehicles (BEV), plug-in hybrid electric vehicles (PHEV), or hybrid electric vehicles (HEV) has been advanced in the automobile industry. A battery usually includes a cathode layer, an anode layer, and an electrolyte layer arranged between the cathode layer and the anode layer. Also, as an anode active material used for the anode layer, an active material containing a Si element (Si-based active material) has been known. For example, Patent Literature 1 discloses an anode for secondary battery containing a composite particle including a plurality of porous silicon particles and a binder.

### CITATION LIST

### Patent Literature

Patent Literature 1: Japanese Patent Application Laid-Open (JP-A) No. 2024-017797

### SUMMARY OF DISCLOSURE

### Technical Problem

While a Si-based active material is an active material with high capacity, the volume change along with charge and discharge is large. When the volume change along with charge and discharge is large, cracks are easily generated in the anode layer, and when the cracks are generated, performance of the anode layer is easily degraded (for example, increase in resistance, and degrade in cycle properties). For this reason, it has been required to suppress the volume change due to charge and discharge in the anode layer containing the Si-based active material.

The present disclosure has been made in view of the above circumstances, and a main object thereof is to provide an anode mixture capable of obtaining an anode layer of which volume change due to charge and discharge is suppressed.

### Solution to Problem

[1]

An anode mixture comprising an anode active material and a solid electrolyte, wherein the anode mixture includes, as the anode active material, a secondary particle that is an aggregation of a plurality of primary particle;
the primary particle is a Si-based active material containing a Si element;
a particle size D₅₀ of the secondary particle is 2.5 μm or more and less than 20 μm; and
a particle size D₅₀ of the solid electrolyte is 0.05 μm or more and less than 2.0 μm.
   [2]

The anode mixture according to [1], wherein
the particle size D₅₀ of the secondary particle is 5.0 μm or more and 15 μm or less, and
the particle size D₅₀ of the solid electrolyte is 0.1 μm or more and 1.0 μm or less.
   [3]

The anode mixture according to [1] or [2], wherein the particle size D₅₀ of the primary particle is 0.3 μm or more and 3.0 μm or less.

[4]

The anode mixture according to any one of [1] to [3], wherein the particle size D₅₀ of the primary particle is 0.5 μm or more and 2.5 μm or less.

[5]

The anode mixture according to any one of [1] to [4], wherein the primary particle is a porous particle.

[6]

The anode mixture according to any one of [1] to [5], wherein a rate of the particle size D₅₀ of the solid electrolyte with respect to the particle size D₅₀ of the secondary particle is 0.5% or more and 15% or less.

[7]

The anode mixture according to any one of [1] to [6], wherein the secondary particle is a particle in which the plurality of primary particle is aggregated by a binder.

[8]

The anode mixture according to any one of [1] to [7], wherein the solid electrolyte is a sulfide solid electrolyte.

[9]

The anode mixture according to [8], wherein the sulfide solid electrolyte contains a Li element, a P element, and a S element.

A solid state battery comprising a cathode layer, an anode layer, and an electrolyte layer that is arranged between the cathode layer and the anode layer, and contains a solid electrolyte, wherein
the anode layer contains the anode mixture according to any one of [1] to [9].

### Advantageous Effects of Disclosure

The anode mixture in the present disclosure exhibits an effect of obtaining an anode layer of which volume change due to charge and discharge is suppressed.

### BRIEF DESCRIPTION OF DRAWINGS

FIG. 1 is a schematic cross-sectional view exemplifying the solid state battery in the present disclosure.

FIG. 2 is a graph showing the results of change in restraining pressure and resistance in the solid state batteries produced in Examples 1 to 4 and Comparative Example 1.

FIG. 3 is a graph showing the results of change in restraining pressure and resistance in the solid state batteries produced in Examples 5 to 8 and Comparative Example 2.

FIG. 4 is a graph showing the results of change in restraining pressure and resistance in the solid state batteries produced in Examples 9 to 14.

### DESCRIPTION OF EMBODIMENTS

The anode mixture and the solid state battery in the present disclosure will be hereinafter explained in details.

### A. Anode Mixture

The anode mixture in the present disclosure contains an anode active material and a solid electrolyte. Also, the anode mixture includes, as the anode active material, a secondary particle that is an aggregation of a plurality of primary particle. The primary particle is a Si-based active material containing a Si element. Also, the particle size D₅₀ of the secondary particle and the particle size D₅₀ of the solid electrolyte are in the specified range.

According to the present disclosure, the anode active material includes the secondary particle that is an aggregation of a plurality of primary particle (Si-based active material), and the particle size D₅₀ of the secondary particle and the particle size D₅₀ of the solid electrolyte are in the specified range, and thus the anode mixture capable of obtaining an anode layer of which volume change due to charge and discharge is suppressed, can be achieved. As described above, while the Si-based active material is an active material with high capacity, the volume change along with charge and discharge is large. When the volume change along with charge and discharge is large, cracks are easily generated in the anode layer, and when the cracks are generated, performance of the anode layer is easily degraded (for example, increase in resistance, and degrade in cycle properties). For this reason, it has been required to suppress the volume change due to charge and discharge in the anode layer containing the Si-based active material.

Then, inventors of the present application have studied about aggregating a plurality of primary particle (Si-based active material) to form a secondary particle (composite particle). Such a secondary particle includes voids among primary particles. The voids can absorb the volume change of the primary particle, and can decrease the volume change of the secondary particle due to charge and discharge; as a result, the volume change of the anode layer due to charge and discharge can also be reduced.

The inventors of the present application have pursued earnest studies about suppressing the volume change of the anode layer due to charge and discharge, and obtained a new knowledge that the extent of the volume change of the anode layer due to charge and discharge basically varies with the particle size D₅₀ of the secondary particle, but surprisingly, not only it is influenced by the particles size D₅₀ of the secondary particle, but also greatly influenced by the particle size D₅₀ of the solid electrolyte. Then, it has been found out that the volume change of the anode layer due to charge and discharge can be effectively suppressed by setting the particle size D₅₀ of the secondary particle and the particle size D₅₀ of the solid electrolyte in the specified range. Further, it has been found out that the resistance of the anode layer may be decreased and the cycle properties may be improved by setting the particle size D₅₀ of the secondary particle and the particle size D₅₀ of the solid electrolyte in the later described specified range.

### 1. Anode Active Material

The anode mixture contains an anode active material. The anode active material includes a secondary particle that is an aggregation of a plurality of primary particle. The particle size D₅₀ of the secondary particle is, usually 2.5 μm or more and less than 20 μm. The particle size D₅₀ of the secondary particle may be 3.0 μm or more, and may be 5.0 μm or more. When the particle size D₅₀ of the secondary particle is too small, there is a possibility that the volume change of the secondary particle due to charge and discharge may not be sufficiently decreased. Meanwhile, the particle size D₅₀ of the secondary particle may be 19 μm or less, may be 17 μm or less, and may be 15 μm or less. When the particle size D₅₀ of the secondary particle is too large, there is a possibility that the resistance of the anode layer may not be sufficiently decreased. In the present disclosure, the particle size D₅₀ refers to 50% accumulation particle size in a volume-based particle distribution by a laser diffraction particle distribution measurement device.

### (1) Primary Particle

The primary particle in the present disclosure is a Si-based active material containing a Si element. Examples of the Si-based active material may include a simple substance Si, a Si alloy, a Si oxide, a Si carbide, and a Si oxycarbide (silicon oxycarbide). The Si alloy is an alloy mainly composed of a Si element. Examples of the metals other than Si in the Si alloy may include at least one kind of W, Mo, Cr, V, Nb, Fe, Ti, Zr, Hf and Os. Examples of the Si oxide may include Sio. Also, the Si-based active material may include a diamond type crystal phase as a main phase, may include a clathrate I type crystal phase as a main phase, and may include a clathrate II type crystal phase as a main phase.

The primary particle in the present disclosure may be a solid particle and may be a porous particle, but the latter is preferable. Since the porous particle includes voids inside, the volume change of the particles can be absorbed, and as a result, the volume change of the anode layer due to charge and discharge can be decreased.

The void rate of the porous particle is, for example, 4% or more, and may be 10% or more. Meanwhile, the void rate of the porous particle is, for example, 40% or less and may be 20% or less. The void rate can be obtained by following procedures. First, an ion milling processing is performed to the electrode layer including the active material to take out the cross-section. Then, the cross-section is observed by a SEM (scanning electron microscope) to obtain a picture of particles. From the obtained picture, a silicon portion and the void portion are distinguished using an image analyzing software, and binarized. The areas of the silicon portion and the void portion are obtained, and the void rate (%) is calculated from the below equation.

Void rate (%)=(Area of void portion)/((Area of

silicon portion)+(Area of void portion))*100

It is preferable that the porous particle includes a lot of minute voids of which pore diameter is 100 nm or less. The voids of which pore diameter is 100 nm or less can prevent the voids from being crushed by pressing, compared to the voids of which pore diameter is larger than 100 nm. The void amount X (integrating hole volume) of the voids of which pore diameter is 100 nm or less is, for example, 0.05 cc/g or more, may be 0.10 cc/g or more, and may be 0.12 cc/g or more. Meanwhile, the void amount X is, for example, 0.40 cc/g or less. The void amount in the present disclosure can be obtained by, for example, a BET measurement.

It is preferable that the porous particle includes a lot of minute voids of which pore diameter is 50 nm or less. The voids of which pore diameter is 50 nm or less can further prevent the voids from being crushed by pressing compared to the voids of which pore diameter is 100 nm or less. The void amount Y of the voids of which pore diameter is 50 nm or less is, for example, 0.05 cc/g or more, may be 0.075 cc/g or more, and may be 0.10 cc/g or more. Meanwhile, the void amount Y is, for example, 0.25 cc/g or less.

It is preferable that the porous particle includes a lot of minute voids of which pore diameter is 10 nm or less. The voids of which pore diameter is 10 nm or less can store the deposited Li with high filling rate compared to the voids of which pore diameter is larger than 10 nm, and thus the volume change due to charge and discharge can be suppressed. The void amount Z of the voids of which pore diameter is 10 nm or less is, for example, 0.015 cc/g or more, may be 0.02 cc/g or more, and may be 0.03 cc/g or more. Meanwhile, the void amount Z is, for example, 0.09 cc/g or less.

Examples of the method for forming the porous particle may include a method in which a LiSi alloy is produced by bringing the primary particle (Si-based active material) that is a solid particle into reaction with a metal Li, and then Li is removed from the LiSi alloy. The LiSi alloy may be obtained by, for example, mixing the primary particle (Si-based active material) with the metal Li. The molar ratio of Li with respect to Si, which is Li/Si is, for example, 1.0 or more, may be 2.0 or more, may be 3.0 or more, and may be 4.0 or more. Meanwhile, Li/Si is, for example, 8.0 or less. Examples of the method for removing Li from the LiSi alloy may include a method in which the LiSi alloy is brought into reacting with Li extracting agent. Examples of the Li extracting agent may include alcohol such as methanol, ethanol, 1-propanol, 1-butanol, 1-pentanol, and 1-hexanol; and acid such as acetic acid, formic acid, propionic acid, and oxalic acid.

Other examples of the method for forming the porous particle may include a method in which a MgSi alloy is produced by bringing the primary particle (Si-based active material) that is a solid particle into reaction with a metal Mg, and then Mg is removed from the MgSi alloy. The Mg—Si alloy can be obtained by, for example, heating a mixture of the primary particle (Si-based active material) and the metal Mg. The rate of Mg with respect to Si, which is Mg/Si is, for example, 1.0 or more, may be 1.5 or more, and may be 2.0 or more. Meanwhile, Mg/Si is, for example, 6.0 or less. Examples of the method for removing Mg from the MgSi alloy may include a method in which Mg in the MgSi alloy is changed to MgO by heating the MgSi alloy in an inert gas atmosphere containing oxygen, and then MgO is removed by an acid solution. Examples of the acid solution may include an aqueous solution containing hydrochloric acid (HCl) and hydrogen fluoride (HF).

The particle size D₅₀ of the primary particle is not particularly limited, but for example, it is 0.3 μm or more, and may be 0.5 μm or more. Meanwhile, the average particle size D₅₀ of the primary particle is, for example, 3.0 μm or less, and may be 2.5 μm or less. Also, from a granule side, in the volume based particle distribution by a laser diffraction particle distribution measurement device, D₁₀ designates a particle size of 10% accumulation, and D₉₀ designates a particle size of 90% accumulation. (D₉₀−D₁₀)/D₅₀ means the spread of the distribution, and the smaller the value of (D₉₀−D₁₀)/D₅₀, the narrower the distribution. In the primary particle, there are no particular limitations on (D₉₀−D₁₀)/D₅₀, but for example, it is 0.1 or more and 3.0 or less, and may be 0.3 or more and 2.0 or less.

The BET specific surface area of the primary particle is not particularly limited, and for example, it is 1 m²/g or more, may be 10 m²/g or more, may be 20 m²/g or more, and may be 30 m²/g or more. Meanwhile, the BET specific surface area of the primary particle is, for example, 200 m²/g or less and may be 150 m²/g or less.

### (2) Secondary Particle

The secondary particle is a particle in which a plurality of primary particle is aggregated. The secondary particle is, for example, a particle in which the plurality of primary particle is aggregated by a binder. Examples of the binder may include a rubber-based binder such as butadiene rubber (BR) and styrene butadiene rubber (SBR), and a fluoride-based binder such as polyvinylidene fluoride (PVdF). In the secondary particle, the proportion of the binder with respect to a total of the plurality of primary particle and the binder is, for example, 1 mass % or more and 30 mass % or less, and may be 5 mass % or more and 25 mass % or less. Meanwhile, the secondary particle may be a burned body in which the plurality of primary particle is aggregated. Also, there are no particular limitations on (D₉₀−D₁₀)/D₅₀ in the secondary particle, but for example, it is 0.1 or more and 5.0 or less, and may be 0.3 or more and 1.0 or less.

There are no particular limitations on the method for forming the secondary particle, and examples thereof may include a spray-dry method. In the spray-dry method, a slurry containing the plurality of primary particle, the binder, and a dispersion medium is sprayed into a hot air to be dried. When the secondary particle including the porous particle as the primary particle is formed, first, the primary particle that is the porous particle is prepared, and then the secondary particle may be formed using the primary particle. Alternatively, first, the primary particle that is a solid particle is prepared, and then, the secondary particle is formed using the primary particle, and after that, the primary particle configuring the secondary particle may be made into porous.

### 2. Solid Electrolyte

The anode mixture contains a solid electrolyte. In the present disclosure, a particle size D₅₀ of the solid electrolyte is usually 0.05 μm or more and less than 2.0 μm. The particle size D₅₀ of the solid electrolyte may be 0.1 μm or more, may be 0.2 μm or more, and may be 0.3 μm or more. Meanwhile, the particle size D₅₀ of the solid electrolyte may be 1.8 μm or less, may be 1.5 μm or less, may be 1.2 μm or less, and may be 1.0 μm or less. Both when the particle size D₅₀ of the solid electrolyte is too small and too large, there is a possibility that the volume change of the anode layer due to charge and discharge may not be sufficiently suppressed.

Also, the rate of the particle size D₅₀ of the solid electrolyte with respect to the particle size D₅₀ of the secondary particle, which is SE/Si2 is not particularly limited, but for example, it is 0.5% or more, may be 1.0% or more, may be 1.2% or more, and may be 1.5% or more. Meanwhile, the rate SE/Si2 is, for example, 15% or less, may be 12% or less, may be 10% or less, and may be 5% or less.

Examples of the solid electrolyte may include an inorganic solid electrolyte such as a sulfide solid electrolyte, an oxide solid electrolyte, a nitride solid electrolyte, a halide solid electrolyte and a solid electrolyte.

The sulfide solid electrolyte is a solid electrolyte containing a sulfur element (S element) as a main component of the anion element. Examples of the sulfide solid electrolyte may include a solid electrolyte containing a Li element, an X element (X is at least one kind of P, As, Sb, Si, Ge, Sn, B, Al, Ga, and In), and a S element. The sulfide solid electrolyte may contain one kind of the element, and may contain two kinds or more of the element as the X element. The sulfide solid electrolyte preferably contains a P element as the X element. The sulfide solid electrolyte may further contain at least one of an O element and a halogen element. Examples of the halogen element may include a F element, a Cl element, a Br element, and an I element.

The sulfide solid electrolyte may be glass (amorphous), may be glass ceramic, and may be a crystalline. The sulfide solid electrolyte may include a crystal phase. Examples of the crystal phase may include a Thio-LISICON type crystal phase, an argyrodite type crystal phase, and a LGPS type crystal phase.

There are no particular limitations on the composition of the sulfide solid electrolyte, and examples thereof may include xLi₂S·(1−x)P₂S₅ (0.5≤x<1), and yLiI·zLiBr·(100−y−z) (xLi₂S·(1−x)P₂S₅) (0.5≤x<1, 0≤y≤30, 0≤z≤30). In these compositions, x preferably satisfies 0.7≤x≤0.8. Also, other examples of the composition of the sulfide solid electrolyte may include Li₇₋ₓPS₆₋ₓXₓ. X is at least one kind of F, Cl, Br and I, and x satisfies 0≤x≤ 2. Also, other examples of the composition of the sulfide solid electrolyte may include Li₄₋ₓMe₁₋ₓPₓS₄ (0<x<1). Me is at least one kind of Al, Zn, In, Ge, Si, Sn, Sb, Ga and Bi.

The oxide solid electrolyte is a solid electrolyte containing an oxygen element as a main component of the anion element, the nitride solid electrolyte is a solid electrolyte containing a nitrogen element as a main component of the anion element, and the halide solid electrolyte is a solid electrolyte containing a halogen element as a main component of the anion element. As these solid electrolytes, known arbitrary solid electrolytes may be adopted. The solid content ratio of the solid electrolyte in the anode mixture is, for example, 10 mass % or more and 50 mass % or less, and may be 20 mass % or more and 40 mass % or less.

### 3. Anode Mixture

The anode mixture may further contain a conductive material. Examples of the conductive material may include a carbon-based conductive material and a metal-based conductive material. Examples of the carbon-based conductive material may include a particulate carbon-based conductive material such as acetylene black (AB) and Ketjen black (KB), and a fiber carbon-based conductive material such as carbon fiber, carbon nanotube (CNT), and carbon nanofiber (CNF). Also, the fiber carbon-based conductive material is preferably carbon nanotube (CNT) such as a single layer carbon nanotube (SWCNT), and a multi-layer carbon nanotube (MWCNT). Also, when the conductive material is in a particle shape, the particle size D₅₀ of the conductive material is not particularly limited, but for example, it is 10 nm or more and 10 μm or less, may be 20 nm or more and 1 μm or less, and may be 30 nm or more and 500 nm or less. The solid content ratio of the conductive material in the anode mixture is, for example, 0.05 mass % or more and 3 mass % or less.

The anode mixture may further contain a binder (second binder) not configuring the second particle, other than the above described binder (first binder) configuring the secondary particle. The kinds of the second binder are in the same contents as those described for the above described first binder. The solid content ratio of the second binder in the anode mixture is, for example, 0.1 mass % or more and 5 mass % or less.

The anode mixture may or may not further contain a dispersion medium. Examples of the dispersion medium may include butyl acetate, butyl butyrate, mesitylene, tetralin, heptane, and N-methyl-2-pyrolidone (NMP). When the anode mixture contains the dispersion medium, the solid content ratio of the anode mixture is, for example, 20 mass % or more and 80 mass % or less. Also, the anode mixture is usually used for a battery, and preferably used for a solid state battery.

### B. Solid State Battery

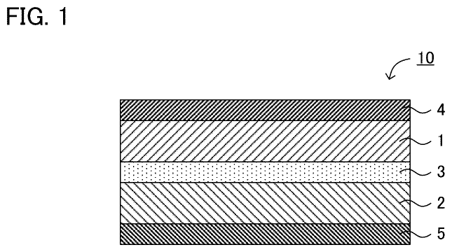

FIG. 1 is a schematic cross-sectional view exemplifying the solid state battery in the present disclosure. Solid state battery 10 shown in FIG. 1 includes cathode layer 1, anode layer 2, electrolyte layer 3 that is arranged between the cathode layer 1 and the anode layer 2 and contains a solid electrolyte, cathode current collector 4 for collecting currents of the cathode layer 1, and anode current collector 5 for collecting currents of the anode layer 2. In the present disclosure, the anode layer 2 contains the anode mixture described in “A. Anode mixture” above.

According to the present disclosure, usage of the above described anode mixture allows a solid state battery to have less volume change due to charge and discharge.

### 1. Anode Layer

The anode layer contains the above described anode mixture. The anode mixture is in the same contents as those described in “A. Anode mixture” above. The thickness of the anode layer is, for example, 0.1 μm or more and 500 μm or less, may be 0.1 μm or more and 100 μm or less, and may be 0.1 μm or more and 50 μm or less. Also, examples of the method for forming the anode layer may include a method in which the anode mixture containing a dispersion medium is applied on the anode current collector and dried.

### 2. Cathode Layer

The cathode layer usually contains a cathode mixture. The cathode mixture contains at least a cathode active material, and may further contain at least one of a solid electrolyte, a conductive material and a binder.

Examples of the cathode active material may include an oxide active material. Examples of the oxide active material may include a rock salt bed type active material such as LiCoO₂, LiMnO₂, LiNiO₂, LiVO₂, LiNi_{1/3}Co_{1/3}Mn_{1/3}O₂ and LiNi_{0.8}Co_{0.15}Al_{0.05}O₂; a spinel type active material such as LiMn₂O₄, Li₄Ti₅O₁₂, and Li (Ni_{0.5}Mn_{1.5})O₄; and an olivine type active material such as LiFePO₄, LiMnPO₄, LiNiPO₄, and LiCoPO₄.

A coating layer containing Li-ion conductive oxide may be formed on the surface of the oxide active material. The reason therefor is to inhibit the reaction of the oxide active material and the solid electrolyte (particularly a sulfide solid electrolyte). Examples of the Li-ion conductive oxide may include LiNbO₃. The thickness of the coating layer is, for example, 1 nm or more and 30 nm or less.

The solid electrolyte, the conductive material and the binder to be used in the cathode mixture are in the same contents as those described in “A. Anode mixture” above. Also, the thickness of the cathode layer is, for example, 0.1 μm or more and 500 μm or less, may be 0.1 μm or more and 100 μm or less, and may be 0.1 μm or more and 50 μm or less. Also, examples of the method for forming the cathode layer may include a method in which the cathode mixture containing a dispersion medium is applied on the cathode current collector and dried.

### 3. Electrolyte Layer

The electrolyte layer is formed between the cathode layer and the anode layer, and contains a solid electrolyte. The electrolyte layer may further contain a binder. The solid electrolyte and the binder are in the same contents as those described in “A. Anode mixture” above. Also, the thickness of the electrolyte layer is, for example, 0.1 μm or more and 500 μm or less, may be 0.1 μm or more and 100 μm or less, and may be 0.1 μm or more and 50 μm or less.

### 4. Other Constitutions

The solid state battery in the present disclosure preferably includes a cathode current collector for collecting currents of the cathode layer, and an anode current collector for collecting currents of the anode layer. Examples of the material for the cathode current collector may include SUS, aluminum, nickel, iron, titanium, and carbon. Meanwhile, examples of the material for the anode current collector may include SUS, copper, nickel, and carbon.

The solid state battery in the present disclosure may further include a restraining jig that applies a restraining pressure along with the thickness direction of the cathode layer, the electrolyte layer and the anode layer. The restraining pressure is, for example, 0.1 MPa or more, may be 1 MPa or more, and may be 5 MPa or more. Meanwhile, the restraining pressure is, for example, 100 MPa or less, may be 50 MPa or less, and may be 20 MPa or less.

### 5. Solid State Battery

The kind of the solid state battery in the present disclosure is not particularly limited, but is typically a lithiμm ion battery. Also, the solid state battery in the present disclosure may be a primary battery and may be a secondary battery, but preferably a secondary battery among them. The reason therefor is to be repeatedly charged and discharged and useful as a car-mounted battery for example. The solid state battery may be a semisolid state battery and may be an all solid state battery.

Examples of the applications of the solid state battery may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably used as a power source for driving hybrid electric vehicles (HEV), plug-in hybrid electric vehicles (PHEV), and battery electric vehicles (BEV). Also, the solid state battery may be used as a power source for moving bodies other than vehicles (such as rail road transportation, vessel and airplane), and may be used as a power source for electronic products such as information processing equipment. Also, there are no particular limitations on the method for producing the solid state battery, and known methods can be used.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

### <Production of Primary Particle>

Si particles (from Kojundo Chemical Laboratory Co., Ltd.) 0.65 g and Li metal (from Honjo Metal Co., Ltd.) 0.60 g were mixed by an agate mortar under an Ar atmosphere to obtain a LiSi precursor. In a glass reactor under an Ar atmosphere, the LiSi precursor 1.0 g, and a dispersion medium (1,3,5-trimethyl benzene from NACALAI TESQUE, INC.) 125 ml were mixed using an ultrasonic homogenizer (UH-50 from SMT Corporation). The obtained LiSi precursor dispersion solution after mixing was cooled to 0° C., ethanol (from NACALAI TESQUE, INC.) 125 ml as a Li extracting solvent was dropped and reacted for 120 minutes. After the reaction, acetic acid (from NACALAI TESQUE, INC.) 50 ml was further dropped and reacted for 60 minutes. After the reaction, a solution and a solid reactant were separated by sucking filtration. The obtained solid reactant was vacuum-dried at 120° C. for 2 hours to collect a porous primary particle (nano-porous Si). The collected primary particle was classified, and the particle size D₅₀ of the primary particle was adjusted to 1.5 μm.

### <Production of Secondary Particle>

The obtained primary particle (nano-porous Si) and a PVDF-HFP-based binder (from KUREHA CORPORATION) were dispersed in dimethyl carbonate (from NACALAI TESQUE, INC.) so as to be in the ratio of the primary particle: the binder=100:13.3 (mass ratio), dissolved partially, and thereby a slurry was obtained. This slurry was sprayed in a spray drier of a nitrogen gas atmosphere at 140° C. and dried to obtain a secondary particle that is an aggregation of a plurality of primary particle. The obtained secondary particle was classified, and the particle size D₅₀ of the secondary particle was adjusted to 2.5 μm.

### <Production of Anode Layer>

The obtained secondary particle (D₅₀=2.5 μm) 1.0 g, a conductive material (VGCF from SHOWA DENKO K.K) 0.04 g, a sulfide solid electrolyte (LiI—LiBr—Li₃PS₄-based sulfide solid electrolyte, D₅₀=0.2 μm) 0.776 g, a binder (PVdF from KUREHA CORPORATION) 0.02 g, and butyl butyrate (from KISHIDA CHEMICAL CO., LTD.) 1.7 g were mixed using an ultrasonic homogenizer (UH-50 from SMT Corporation), and thereby an anode slurry (anode mixture) was produced. This anode slurry was applied on an anode current collector (Ni foil) by a blade method, dried in the conditions of 100° C. for 30 minutes on a hot plate, and thereby an anode layer (30 μm thick) was obtained.

### <Production of Cathode Layer>

A cathode active material (LiNi_{1/3}Co_{1/3}Mn_{1/3}O₂ coated with LiNbO₃) 1.5 g, a conductive material (VGCF, from SHOWA DENKO K.K) 0.023 g, a sulfide solid electrolyte (LiI—LiBr—Li₃PS₄-based sulfide solid electrolyte, D₅₀=0.2 μm) 0.239 g, a binder (PVdF from KUREHA CORPORATION) 0.011 g, and butyl butyrate (from KISHIDA CHEMICAL CO., LTD.) 0.8 g were mixed using an ultrasonic homogenizer (UH-50 from SMT Corporation), and thereby a cathode slurry was produced. This cathode slurry was applied on a cathode current collector (Al foil) by a blade method, dried in the conditions of 100° C. for 30 minutes on a hot plate, and thereby a cathode layer was obtained.

### <Production of Solid Electrolyte Layer>

A sulfide solid electrolyte (LiI—LiBr—Li₃PS₄-based sulfide solid electrolyte), a binder (PVdF, from KUREHA CORPORATION), and a dispersion medium (butyl butyrate) were dispersed by an ultrasonic dispersion device, and thereby a slurry for solid electrolyte layer was produced. This slurry was applied on a transferring foil (Al foil) by a blade method, dried in the conditions of 100° C. for 30 minutes on a hot plate, and thereby a transferring foil including a solid electrolyte layer was obtained.

### <Production of Battery>

The cathode layer and the solid electrolyte layer were layered so as to face to each other. After pressing with a pressing pressure of 50 kN/cm and a temperature of 160° C. by a roll pressing machine, the transferring foil (Al foil) was peeled off from the solid electrolyte layer, punched out into a size of 1 cm², and thereby a cathode layered body was obtained. Next, the anode layer and the solid electrolyte layer were layered so as to face to each other. After pressing with a pressing pressure of 50 kN/cm by a roll pressing machine, the transferring foil (Al foil) was peeled off from the solid electrolyte layer, and thereby an anode layered body was obtained. Further, the solid electrolyte layer was layered so as to face to the solid electrolyte layer side of the anode layered body. This layered body was temporary pressed at a pressing pressure of 100 MPa and a temperature of 25° C. with a plane uniaxial pressing machine, and then the transferring foil (Al foil) was peeled off from the solid electrolyte layer, punched out into a size of 1.08 cm², and thereby an anode layered body including an additional solid electrolyte layer was obtained.

The cathode layered body and the anode layered body including the additional solid electrolyte layer were layered so as to face to each other. This layered body was pressed at a pressing pressure of 600 MPa and a temperature of 160° C. with a plane uniaxial pressing machine, and thereby a battery layered body was obtained. The obtained battery layered body was sandwiched between two pieces of restraining plates, restrained at a restraining pressure of 1 MPa to fix the distance between the two pieces of restraining plates, and thereby a battery was obtained.

### Examples 2 to 4 and Comparative Example 1

A battery was respectively produced in the same manner as in Example 1 except that the particle size D₅₀ of the secondary particle was changed to values shown in Table 1.

### Examples 5 to 8 and Comparative Example 2

A battery was respectively produced in the same manner as in Example 3 except that the particle size D₅₀ of the sulfide solid electrolyte was changed to values shown in Table 2.

### Examples 9 to 14

A battery was respectively produced in the same manner as in Example 3 except that the particle size D₅₀ of the primary particle was changed to values shown in Table 3.

### [Evaluation]

### <Change in Restraining Pressure>

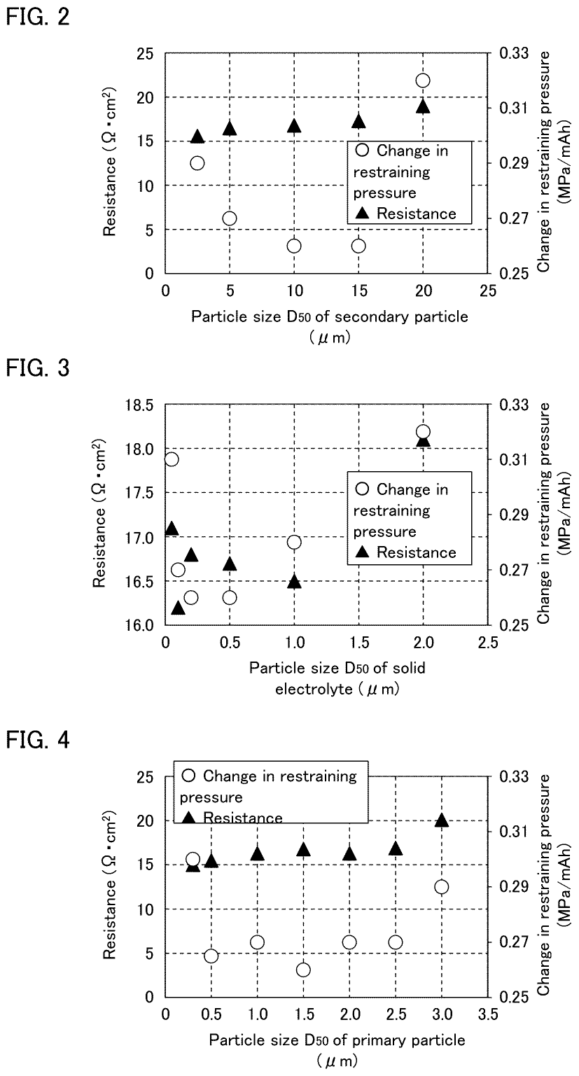

The batteries obtained in Examples 1 to 14 and Comparative Examples 1 and 2 were CC/CV charged at 0.245 mA until 4.55 V, and then CC/CV discharged at 0.245 mA until 3.0 V. On this occasion, the change in restraining pressure (ΔMPa/mAh) per battery capacity was respectively obtained. The results are shown in Table 1 to Table 3 and FIG. 2 to FIG. 4.

### <Resistance>

The batteries obtained in Examples 1 to 14 and Comparative Examples 1 and 2 were CC/CV charged at 0.3 mA until 4.35 V, and then CC/CV discharged at 0.3 mA until 2.5 V. This charge and discharge operation was repeated for 5 times. After that, the voltage was adjusted to 3.7 V, and then current of 10 mA was applied for 5 seconds. The direct current internal resistance (DCIR) was obtained from the relation between the voltage drop amount and the current at the time of discharge. The results are shown in Table 1 to Table 3 and FIG. 2 to FIG. 4.

### <Capacity Durability>

The batteries obtained in Examples 1 to 14 and Comparative Examples 1 and 2 were CC/CV charged at 0.3 mA until 4.35 V, and then CC/CV discharged at 0.3 mA until 2.5 V, and the initial discharge capacity was obtained. After that, the charge and discharge was repeated, and the discharge capacity at the 100th cycle was obtained. The capacity durability (%) was respectively calculated by dividing the discharge capacity at the 100th cycle by the initial discharge capacity. The results are shown in Table 1 to Table 3.

TABLE 1

| | | | | | Change in | | |
|---|---|---|---|---|---|---|---|
| | | | | | restraining | | Capacity |
| | D50_Si1 | D50_Si2 | D50_SE | SE/Si2 | pressure | Resistance | durability |
| | (μm) | (μm) | (μm) | (%) | (MPa/mAh) | (Ω · cm²) | (%) |
| Ex. 1 | 1.5 | 2.5 | 0.2 | 8.0 | 0.29 | 15.6 | 88 |
| Ex. 2 | | 5 | | 4.0 | 0.27 | 16.5 | 91 |
| Ex. 3 | | 10 | | 2.0 | 0.26 | 16.8 | 92 |
| Ex. 4 | | 15 | | 1.3 | 0.26 | 17.3 | 90 |
| Comp. | | 20 | | 1.0 | 0.32 | 19.0 | 80 |
| Ex. 1 | | | | | | | |

TABLE 2

| | | | | | Change in | | |
|---|---|---|---|---|---|---|---|
| | | | | | restraining | | Capacity |
| | D50_Si1 | D50_Si2 | D50_SE | SE/Si2 | pressure | Resistance | durability |
| | (μm) | (μm) | (μm) | (%) | (MPa/mAh) | (Ω · cm²) | (%) |
| Ex. 5 | 1.5 | 10 | 0.05 | 0.5 | 0.31 | 17.1 | 87 |
| Ex. 6 | | | 0.1 | 1.0 | 0.27 | 16.2 | 91 |
| Ex. 3 | | | 0.2 | 2.0 | 0.26 | 16.8 | 92 |
| Ex. 7 | | | 0.5 | 5.0 | 0.26 | 16.7 | 92 |
| Ex. 8 | | | 1 | 10 | 0.28 | 16.5 | 93 |
| Comp. | | | 2 | 20 | 0.32 | 18.1 | 85 |
| Ex. 2 | | | | | | | |

TABLE 3

| | | | | | Change in | | |
|---|---|---|---|---|---|---|---|
| | | | | | restraining | | Capacity |
| | D50_Si1 | D50_Si2 | D50_SE | SE/Si2 | pressure | Resistance | durability |
| | (μm) | (μm) | (μm) | (%) | (MPa/mAh) | (Ω · cm²) | (%) |
| Ex. 9 | 0.3 | 10 | 0.2 | 2.0 | 0.30 | 15.0 | 90 |
| Ex. 10 | 0.5 | | | | 0.265 | 15.5 | 91 |
| Ex. 11 | 1.0 | | | | 0.27 | 16.3 | 92 |
| Ex. 3 | 1.5 | | | | 0.26 | 16.8 | 92 |
| Ex. 12 | 2.0 | | | | 0.27 | 16.3 | 92 |
| Ex. 13 | 2.5 | | | | 0.27 | 16.9 | 90 |
| Ex. 14 | 3.0 | | | | 0.29 | 20.1 | 87 |

As shown in Table 1 and FIG. 2, change in restraining pressure of Examples 1 to 4 was respectively smaller than that of Comparative Example 1. In particular, the change in restraining pressure of Examples 2 to 4 was respectively remarkably smaller compared to that of Comparative Example 1. In this manner, it was confirmed that the anode mixtures produced in Examples 1 to 4 were capable of obtaining an anode layer of which volume change due to charge and discharge is suppressed. Also, as shown in Table 1 and FIG. 2, it was confirmed that the resistance of Examples 1 to 4 was respectively lower, and the capacity durability was respectively higher than those of Comparative Example 1, which means that both the reduction of resistance and the improvement of cycle properties were achieved.

As shown in Table 2 and FIG. 3, the change in restraining pressure of Examples 3 and 5 to 8 was respectively smaller than that of Comparative Examples 2. In particular, the change in restraining pressure of Examples 3 and 6 to 8 was respectively remarkably smaller compared to that of Comparative Example 2. In this manner, it was confirmed that the anode mixtures produced in Examples 3 and 5 to 8 were capable of obtaining an anode layer of which volume change due to charge and discharge is suppressed. Also, although the particle size D₅₀ of the secondary particle was 10 μm and the same in all Examples 3, 5 to 8 and Comparative Example 2, the change in restraining pressure and the resistance greatly varied depending on the particle size D₅₀ of the solid electrolyte. In other words, it was confirmed that both the particle size D₅₀ of the secondary particle and the particle size D₅₀ of the solid electrolyte need to be in the specified range at the same time in order to effectively suppress the volume change due to charge and discharge. Also, as shown in Table 2 and FIG. 3, it was confirmed that the resistance is lower and the capacity durability was higher in Examples 3 and 5 to 8 compared to Comparative Example 2, which means that both the decrease in resistance and the improvement in cycle properties were achieved.

As shown in Table 3 and FIG. 4, the change in restraining pressure was small in all Examples 3 and 9 to 14. Also, although the particle size D₅₀ of the secondary particle was same 10 μm and the particle size D₅₀ of the solid electrolyte was same 0.2 μm in all Examples 3 and 9 to 14, the change in restraining pressure and the resistance varied depending on the particle size D₅₀ of the primary particle. In other words, it was confirmed that the particle size D₅₀ of the secondary particle, the particle size D₅₀ of the solid electrolyte, and the particle size D₅₀ of the primary particle are preferably in the specified range at the same time in order to further effectively suppress the volume change due to charge and discharge. Also, as shown in Table 3 and FIG. 4, it was confirmed that the resistance was lower and the capacity durability was higher in Examples 3 and 10 to 13 compared to Example 14, which means that both the decrease in resistance and the improvement in cycle properties were achieved.

### REFERENCE SINGS LIST

1 cathode layer
2 anode layer
3 electrolyte layer
4 cathode current collector
5 anode current collector
10 solid state battery

What is claimed is:

1. An anode mixture comprising an anode active material and a solid electrolyte, wherein
the anode mixture includes, as the anode active material, a secondary particle that is an aggregation of a plurality of primary particle;
the primary particle is a Si-based active material containing a Si element;
a particle size D₅₀ of the secondary particle is 2.5 μm or more and less than 20 μm; and
a particle size D₅₀ of the solid electrolyte is 0.05 μm or more and less than 2.0 μm.

2. The anode mixture according to claim 1, wherein
the particle size D₅₀ of the secondary particle is 5.0 μm or more and 15 μm or less, and
the particle size D₅₀ of the solid electrolyte is 0.1 μm or more and 1.0 μm or less.

3. The anode mixture according to claim 1, wherein the particle size D₅₀ of the primary particle is 0.3 μm or more and 3.0 μm or less.

4. The anode mixture according to claim 1, wherein the particle size D₅₀ of the primary particle is 0.5 μm or more and 2.5 μm or less.

5. The anode mixture according to claim 1, wherein the primary particle is a porous particle.

6. The anode mixture according to claim 1, wherein a rate of the particle size D₅₀ of the solid electrolyte with respect to the particle size D₅₀ of the secondary particle is 0.5% or more and 15% or less.

7. The anode mixture according to claim 1, wherein the secondary particle is a particle in which the plurality of primary particle is aggregated by a binder.

8. The anode mixture according to claim 1, wherein the solid electrolyte is a sulfide solid electrolyte.

9. The anode mixture according to claim 8, wherein the sulfide solid electrolyte contains a Li element, a P element, and a S element.

10. A solid state battery comprising a cathode layer, an anode layer, and an electrolyte layer that is arranged between the cathode layer and the anode layer, and contains a solid electrolyte, wherein
the anode layer contains the anode mixture according to claim 1.
